(19) United States
(12) Patent Application Publication
(10) Pub. No.: US 2026/0301439 A1
(43) Pub. Date: Oct. 1, 2026

(54) INFORMATION ACQUISITION METHOD OF ACQUIRING INFORMATION RELATING TO NUTRITIONAL STATE OF CELL GROUP

(71) Applicant: CANON KABUSHIKI KAISHA, Tokyo (JP)

(72) Inventors: TAKUSHI ICHINOO, Tokyo (JP); HARUKA MAEOKA, Tokyo (JP)

(21) Appl. No.: 19/576,234

(22) Filed: Mar. 24, 2026

(30) Foreign Application Priority Data
Mar. 31, 2025 (JP) 2025-058628

(51) Int. Cl. G06V 20/69; G06T 7/00; G06V 10/70

(52) U.S. Cl. CPC G06V 20/695; G06T 7/0012; G06V 10/70; G06V 20/693; G06T 2207/20081; G06T 2207/30024

(57) ABSTRACT

To acquire, in real-time, information relating to a nutritional state applied to a cell group. The present disclosure provides an information acquisition method including: an image acquisition step of acquiring an image including at least one of a scattered light image of a cell group and an autofluorescence image of the cell group; an extraction step of extracting individual cell regions of the cell group in the image; an intensity distribution acquisition step of acquiring information relating to an intensity distribution of the cell group as a feature value of the cell group; and a nutritional state acquisition step of acquiring information relating to the nutritional state of the cell group, based on the information relating to the intensity distribution of the cell group.

### BACKGROUND

### Field of the Technology

The present disclosure relates to a method, a program, a medium, and an analysis apparatus for analyzing a nutritional state of a cell group by using an image.

### Description of the Related Art

Japanese Patent Laid-Open No. 2015-108549 discloses a configuration in which a difference between confluent and non-confluent cells is identified by cellular autofluorescence. Japanese Patent Laid-Open No. 2006-025789 discloses a system for determining the degree of aging of a culture medium and a replacement timing thereof by autofluorescence.

### SUMMARY

One problem to be addressed is to acquire, in real-time, information relating to a nutritional state applied to a cell group.

The present disclosure provides an information acquisition method of acquiring information relating to a nutritional state of a cell group from an image including the cell group, the information acquisition method including:
an image acquisition step of acquiring an image including at least one of a scattered light image of the cell group and an autofluorescence image of the cell group;
an extraction step of extracting individual cell regions of the cell group in the image;
an intensity distribution acquisition step of calculating intensity information of the individual cell regions, and further acquiring information relating to an intensity distribution of the cell group from the intensity information of the individual cell regions as a feature value of the cell group; and
a nutritional state acquisition step of acquiring information relating to the nutritional state of the cell group, based on the information relating to the intensity distribution of the cell group, wherein
the information relating to the nutritional state includes information relating to an amount of at least one selected from the group consisting of sugars, lactic acid, pyruvic acid, glutamine, glutamic acid, and lipids provided to the cell group.

Features of the present disclosure will become apparent from the following description of embodiments with reference to the attached drawings. The following description of embodiments is described by way of example.

### BRIEF DESCRIPTION OF THE DRAWINGS

FIG. 1 is a flowchart showing a configuration of an information acquisition method in a first embodiment.

FIG. 2 is a diagram for describing an angle formed by a direction of illumination light and a capturing direction.

FIG. 3 is a flowchart showing a configuration of an information acquisition method in a second embodiment.

FIG. 4A is a diagram showing an example of an analysis apparatus being one embodiment of the present disclosure.

FIG. 4B is a diagram showing an example of a functional configuration of an image acquisition apparatus.

FIG. 4C is a diagram showing an example of a functional configuration of an image processing apparatus.

FIG. 5 shows bright-field and autofluorescence image cell images obtained by capturing in Example 1.

FIG. 6 show scatter plots indicating intensities extracted from the cell images in Example 1.

The horizontal axes represent intensity values obtained from the images observed with 365-nm excitation/400-nm or more observation (autofluorescence intensity (B)), and the vertical axes represent intensity values obtained from the images observed with 395-nm excitation/530-nm or more observation (autofluorescence intensity (G)). These correspond to the cultivation results for (1) conditioned medium, (2) glucose supplement conditioned medium, (3) glutamine supplement conditioned medium, and (4) unused medium.

FIG. 7 shows Table 1 showing ratios of a feature value for autofluorescence intensity information in Example 1. The average value of the intensity was used as the feature value, and was calculated for autofluorescence intensity (B) and autofluorescence intensity (G) in FIG. 5.

FIG. 8 shows histograms indicating autofluorescence intensities extracted from the cell images after 24 hours in Example 2. (a) shows intensity values obtained from images observed with 365-nm excitation/400 nm or more observation (autofluorescence intensity (B)), and (b) shows intensity values obtained from images observed with 395-nm excitation/530 nm or more observation (autofluorescence intensity (G)), plotted on the horizontal axis, with frequency represented on the vertical axis.

These results of cultivation are superimposed for (1) glutamine-free medium (light gray), (2) medium containing 1.2 mM glutamine (gray), and (3) medium containing 6 mM glutamine (dark gray).

FIG. 9 shows Table 2 showing ratios of a feature value for autofluorescence intensity information after 24 hours in Example 2. The mode value of the intensity was used as the feature value, and was calculated for autofluorescence intensity (B) and autofluorescence intensity (G).

FIG. 10 shows Table 3 showing ratios of a feature value for autofluorescence intensity information after 48 hours in Example 2. The mode value of the intensity was used as the feature value and is calculated for autofluorescence intensity (G).

FIG. 11 shows a scatter plot indicating scattered light intensities extracted from the cell images after 24 hours in Example 3. Intensity values obtained from images with 525-nm irradiation (scattered light intensity (G)) are shown. These results of cultivation are superimposed for (1) glutamine-free medium (light gray), (2) medium containing 1.2 mM glutamine (gray), and (3) medium containing 6 mM glutamine (dark gray).

FIG. 12 shows Table 4 showing ratios of a feature value for scattered light intensity information after 24 hours in Example 3. The average value of the intensity was used as the feature value and was calculated for scattered light intensity (G).

### DESCRIPTION OF THE EMBODIMENTS

Microstructures of cells change due to a change in nutritional state such as a nutritional deficiency in a culture medium during cell culture, leading to a change in metabolism and the like. For example, structural changes such as mitochondrial morphological abnormalities, lysosomal abnormalities, and changes in cell membranes occur due to stress caused by the nutritional deficiency.

Side-scattered light obtained by irradiating a sample containing particulate matter with light includes information reflecting the complexity of a microstructure of the particulate matter in the sample. By measuring the side-scattered light from the cells, information relating to the nutritional state of the cells can be obtained. On the other hand, several of the coenzymes related to the intracellular reduction state, the metabolic state, and the like emit fluorescence. By observing this fluorescence, the information relating to the nutritional state in the cells can be obtained. By understanding characteristics of a cell population, appropriate operation on the cells in the culture can be performed.

The amount of consumed nutritional components is obtained upon measuring the nutritional components of a culture supernatant of cells maintained in the culture, but it is not known what the actual nutritional state of the cell population is as a whole.

In Japanese Patent Laid-Open No. 2015-108549, an attempt is made to analyze a nutritional state of cells by using autofluorescence, but quantitative evaluation by analyzing image information of a large number of cells is not performed. Information relating to the nutritional state of a cell group is not acquired by using a scattered light image of the cell group. In Japanese Patent Laid-Open No. 2006-025789, information about the age of the culture is acquired by observing the autofluorescence of a background portion of the culture medium, but information of a nutritional state of a cell population cannot be obtained directly, and nutrients are also not identified. Information relating to the nutritional state of a cell group cannot be acquired by using a scattered light image of the cell group.

In a method using a flow cytometer, cells need to be observed in a flow, thus the information relating to the nutritional state cannot be obtained in real-time, and the information relating to the nutritional state cannot be obtained for adherent cells. On the other hand, according to a method of the present disclosure, the information relating to the nutritional state can be obtained for cells during culture, in sections, and in tissue. Therefore, the information relating to the nutritional state can be obtained in real-time, and the information relating to the nutritional state for adherent cells, tissue cells, and the like can be obtained.

Hereinafter, embodiments and variations of the present disclosure will be described with reference to the drawings.

### First Embodiment

### Information Acquisition Method

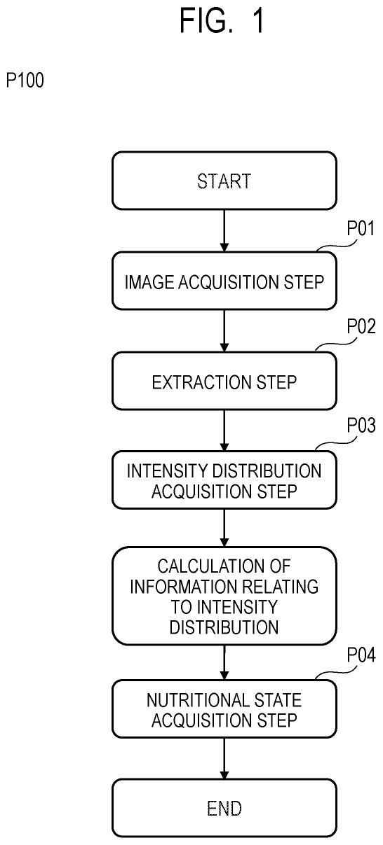

FIG. 1 is a flowchart showing an example of a configuration of an information acquisition method.

The information acquisition method includes: an image acquisition step P01 of capturing a scattered light image or an autofluorescence image of a cell group held in an observation container; an extraction step P02 of extracting individual cell regions of the cell group in the scattered light image or the autofluorescence image; an intensity distribution acquisition step P03 of calculating intensity information for each individual cell region and further acquiring information relating to the intensity distribution of the cell group as a feature value from the intensity information; and a nutritional state acquisition step P04 of acquiring information relating to the nutritional state of the cell group based on the information relating to the intensity distribution. The information relating to the nutritional state includes information relating to an amount of at least one selected from the group consisting of sugars, lactic acid, pyruvic acid, glutamine, glutamic acid, and lipids provided to the cell group.

Hereinafter, an example of an embodiment of each step will be described with reference to FIG. 1.

### Image Acquisition Step

In an image acquisition step, an image including at least one of a scattered light image obtained by capturing scattered light generated by irradiating a cell group with light and an autofluorescence image of the cell group is acquired as information. The image may be acquired as information from a captured image, or may be acquired in real-time.

### Cell Group

Cell group refers to a group including a plurality of cells, and includes any two or more cells. In the method of the present embodiment, any type of cell group is used in the method of the present embodiment, but the cell group can be cells included in one colony, cells included in a plurality of colonies, specific cells selected from among a plurality of cells, cells having a specific phenotype, living cells, cells in a field of view, cells in a culture vessel, and the like.

Mammalian cells can be used for the cells of the cell group. The cells include cultured cells, cells in tissue sections, tissue, and cells extracted from a biological sample. These include normal cells, cancer cells, or mixed cultures or mixed tissue including cancer cells and normal cells, cancer cells with other cancer cells, or normal cells with other normal cells.

In the method of the present embodiment, at least one of a scattered light image of a cell group and an autofluorescence image of the cell group is acquired. These images can be acquired by an image acquisition apparatus such as a camera capturing the cell group via an optical system including a magnifying lens such as a microscope.

The cell group may be in any state provided that the cell group can be captured by the image acquisition apparatus. For example, when the image acquisition apparatus is a typical microscope, the cells of the cell group can be in a suspended, adherent, or cultured state in a petri dish, a plate, a flask, and the like, or may be included in a section. The cells may be those present in a living body, such as blood or tissue, provided that capturing is possible.

The method of the present embodiment is applicable in particular to real-time acquisition of information from the cell group including living cells; however, the cell group is not limited to living cells and may, for example, include fixed cells, and may also be a fixed section.

### Scattered Light Image

Scattered light is emitted light having been scattered by a target. When the illumination light passes through a sample containing particulate matter, light that propagates in a direction different from a propagation direction of the illumination light is referred to herein as side-scattered light. It is known that side-scattered light includes information reflecting the complexity of a microstructure of the particulate matter in the sample. In order to obtain an image of the side-scattered light, the scattered light image is preferably captured by an optical system in which an angle formed by the direction of the illumination light and a capturing direction is 5 degrees or more. The angle formed by the direction of the illumination light and the capturing direction is more preferably 30 degrees or more, and even more preferably 45 degrees or more.

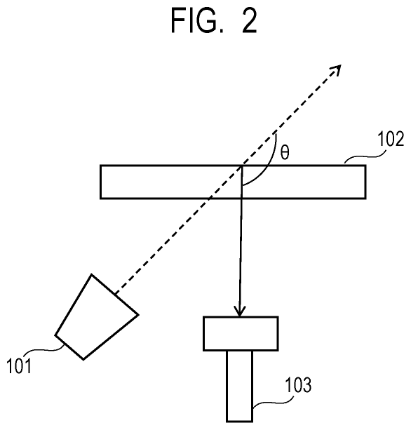

FIG. 2 shows an example of the image acquisition apparatus that acquires an image. The angle formed by the direction of the illumination light and the capturing direction will be described using FIG. 2. 101 indicates an irradiation apparatus, 102 indicates a mounting stage on which a capturing target is placed, and 103 indicates a capturing apparatus. The irradiation apparatus 101 emits straight light such as a laser, and a direction thereof is referred to as the direction of the illumination light as indicated by a dashed arrow in the drawing. The capturing direction is a direction perpendicular to a capturing surface of the capturing apparatus 103 as indicated by a solid arrow. This drawing shows an example in which the capturing direction is perpendicular to the mounting stage 102, but the angle formed by the direction of the illumination light and the capturing direction, or the angle formed by the direction of the illumination light and the mounting stage 102 is not limited. The angle formed by the direction of the illumination light and the capturing direction refers to the smaller angle, and is at most 180 degrees by definition. In the example of the drawing, the angle formed by the direction of the illumination light and the capturing direction is 0.

It is known that a deficiency of nutritional components in a culture medium during cell culture causes a change in the microstructures of cells, such as a morphological change in mitochondria, a change in cell membrane, and formation of distinctive microstructures. For example, mitochondria fragmented due to a deficiency of nutritional components have sizes on the order of several tens to several hundreds of nanometers. Accordingly, it is conceivable that a deficiency of nutritional components increases the microstructures of cells, thereby causing a change in side-scattered light intensity. Alternatively, it is also known that autophagosomes, which are microstructures of about 1 μm, are produced in cells due to a deficiency of nutritional components. As described above, in cells with a deteriorated nutritional state, microstructures of sizes that contribute to an increase in side-scattered light intensity increase due to multiple factors, and thus it is inferred that side-scattered light intensity increases.

One or more scattered light images can be acquired for one sample including a plurality of cells. The scattered light image is obtained from side-scattered light by using illumination light of a specific wavelength at an angle formed by the direction of the illumination light and the capturing direction being 30 degrees or more. The illumination light may be light of one wavelength or light of a plurality of wavelengths. The side-scattered light may be light of one wavelength or light of a plurality of wavelengths.

Examples of wavelengths used for capturing of the scattered light image include 525-nm irradiation/imaging, 470-nm irradiation/imaging, and 660-nm irradiation/imaging; however, the present disclosure is not limited thereto.

### Autofluorescence Image

Autofluorescence refers to fluorescence emitted by matter inherently present in cells, tissue, and the like upon being irradiated with excitation light. In particular, examples of endogenous components that emit autofluorescence include NAD(P)H, flavins (such as FAD), collagen, fibronectin, tryptophan, folic acid, and other autofluorescent molecules produced within cells.

Cells consume nutrient sources to perform metabolism and produce energy in order to survive. Therefore, there is a correlation between cellular metabolism and the nutritional state. For example, deficiency of glucose, which is a substrate for glycolysis, inactivates glycolysis, and deficiency of pyruvate, which is one substrate for a TCA cycle, inactivates the TCA cycle. It has been reported to date that NAD(P)H and flavins (such as FAD), which are mainly produced and consumed in glycolysis and the TCA cycle, reflect the metabolic state of cells.

Therefore, the inventors consider that the nutritional state can be measured by capturing an autofluorescence image of the cell group.

With respect to a change in nutrient source and metabolic pathway activity for each metabolic pathway, detailed reports have not been made because the metabolic pathways influence one another. However, in general, when glycolysis is reduced, mainly a decrease in an abundance ratio of NAD(P)H occurs, and when the TCA cycle is reduced, an increase in an abundance ratio of flavins occurs. These metabolic pathways are not independent and can be interrelated to compensate for a lack of energy. In the cells of Example 1 described below, when a culture medium with insufficient nutrients is used, it is assumed that with the deterioration of the nutritional state, glycolysis is inactivated, the abundance ratio of NAD(P)H decreases, and the abundance ratio of flavins increases due to the decline of the TCA cycle. However, dynamics within the cell remain largely unexplained, and the nutritional state and the corresponding metabolic changes are likely to be influenced by the cell type or the storage and maintenance conditions of the cells.

In the method of the present embodiment, it is not necessary to identify what the endogenous components emitting autofluorescence are, and autofluorescence includes fluorescence emitted by endogenous components other than the fluorescent endogenous components described above.

One or more autofluorescence images can be acquired for one sample including a plurality of cells. The autofluorescence image is obtained from autofluorescence by using excitation light of a specific wavelength. The excitation light may be light of one wavelength or light of a plurality of wavelengths. The fluorescence may be light of one wavelength or light of a plurality of wavelengths.

Examples of wavelengths for capturing the autofluorescence image include 365-nm excitation/430-nm long-pass filter observation, 395-nm excitation/430-nm long-pass filter observation, 395-nm excitation/530-nm long-pass filter observation, or 470-nm excitation/530-nm long-pass filter observation; however, the present disclosure is not limited thereto.

### Extraction Step

In an extraction step, a region of a cell group in a scattered light image or an autofluorescence image is extracted.

### Region Extraction Method

An image for region extraction can be used in the region extraction. The image for region extraction is acquired for obtaining region information of individual cells in the scattered light image or the autofluorescence image of the cell group, and allows identification of the individual cells themselves, cell membranes, nuclei, and other intracellular organelles included in the cell group. The image for region extraction may be a bright-field image, a scattered light image, or an autofluorescence image, and may also be acquired as a bright-field image or a fluorescence image obtained by, for example, staining a specific intracellular organelle such as a nucleus. However, when the image for region extraction is a fluorescence image, an excitation wavelength or a fluorescence wavelength can be selected so that the wavelength does not overlap with the wavelength of a scattered light image or an autofluorescence image. One or more images for region extraction can be acquired for one sample.

### Intensity Distribution Acquisition Step

In an intensity distribution acquisition step, information of individual cell regions determined in the extraction step is associated with a scattered light image or an autofluorescence image, and scattered light or autofluorescence intensity information of the individual cell regions is acquired.

Furthermore, information relating to the intensity distribution of the cell group is calculated from the information of the cell region of the cell group. The information relating to the intensity distribution of the cell group can be used as a feature value of the cell group. The acquired feature value of the cell group can be used as a feature value for machine learning described below.

### Intensity Information Extraction Method

The intensity information of a cell region can be acquired from a scattered light image or an autofluorescence image using the information of the individual cell regions of the cell group determined by the extraction step. The intensity information can include scattered light or autofluorescence intensity, as well as intensity position information, area information, and other information. The intensity is not particularly limited provided the intensity is a value indicating scattered light intensity or autofluorescence intensity, and any type of indicator may be used. Note that intensity can also be referred to as magnitude.

The intensity information of individual cells is extracted from the intensity information of the image and the region information indicating the region of the individual cells described above.

As the intensity information for the individual cells, one or more pieces of scattered light information or autofluorescence information can be determined per cell, and typically, one piece of scattered light information or autofluorescence information is determined per cell.

A statistical value relating to the intensity of the relevant cell can be the scattered light intensity information and the autofluorescence intensity information of that cell. In particular, a minimum value, a maximum value, an average value, a median value, a deviation, and the like can be used in a region indicating the individual cell regions.

### Information Relating to Intensity Distribution

The information relating to the intensity distribution can be used as the feature value of the cell group. The feature value may be a statistical value representing the cell group, a parameter resulting from fitting a distribution, or a numerical value calculated using another method.

In particular, as representative values of the intensity of the cell group, various statistical values are acquired from the autofluorescence or scattered light intensity information of the cell group, including average value, median value, mode value, variance, deviation, interquartile range, half width, and other statistical values.

Alternatively, as a method of acquiring information representing the shape of the distribution of the cell group, one or more pieces of scattered light intensity information or autofluorescence intensity information may be fitted to a theoretical distribution (Gaussian, ex-Gaussian, shifted lognormal, shifted Wald, shifted Weibull, and Gumbel, and the like), and the parameters calculated from the fitting may be used as information relating to the intensity distribution. For the fitting, parameters may be calculated by using a Gaussian mixture model (GMM), which is used in one type of unsupervised machine learning.

Alternatively, information relating to the intensity distribution in multidimensional information when using a plurality of pieces of intensity information. Also in this case, a representative value or a parameter obtained as a result of fitting the distribution may be used as the feature value representing the distribution. Examples of representative values include a Manhattan distance, a Euclidean distance, and a Mahalanobis distance between a centroid of the distribution and the origin.

### Nutritional State Acquisition Step

### Nutritional State

The nutritional state in the present embodiment includes information relating to an abundance amount of sugar, lactic acid, pyruvic acid, glutamine, glutamic acid, and lipids in the cell sample. Sugars include monosaccharides, disaccharides, polysaccharides, and sugar alcohols; examples of monosaccharides include glucose, fructose, mannose, galactose, and ribose, and examples of disaccharides include sucrose, lactose, maltose, and trehalose. Examples of polysaccharides include amylose, amylopectin, glycogen, cellulose, dextran, α-1,3-glucan, agarose, heparin, alginic acid, and hyaluronic acid. Among sugars, glucose can be used.

Lipids include fatty acids, and fatty acids include saturated fatty acids and unsaturated fatty acids.

The abundance amount may be information relating to a specific concentration of each component, or may be information indicating whether the amount of each component exceeds or falls below a predetermined threshold value. The information relating to the nutritional state may be information relating to an interior of the cells or information relating to the culture medium. In the method of the present embodiment, it is not necessary to accurately identify substances that are excessive or deficient in the culture medium.

As described above, since autofluorescence and side-scattered light reflect the nutritional state of the cells, information relating to the abundance amount of these substances present in the sample can be obtained according to the present embodiment.

In the nutritional state acquisition step, the information relating to the nutritional state of the cell group can be acquired by using supervised machine learning. A trained model can be used that has been trained by using the information relating to the intensity distribution as input and the information relating to the nutritional state as output.

Variation: Example in which Machine Learning Model is Used in Nutritional State Acquisition Step

### Machine Learning Model

Machine learning using the feature value and training data can be used. The feature value is a numerical representation of the features of data.

Examples of at least one feature value includes the information relating to the intensity distribution. The scattered light intensity information or the autofluorescence intensity information of the individual cells may be used as the feature value. When a plurality of pieces of scattered light information or autofluorescence information are used, these may be used as additional feature values.

The information relating to the nutritional state can be used as the training data. For example, quantitative numerical values of respective components relating to the nutritional state may be used, information binarized according to whether the numerical values are above or below a threshold value may be used, or information converted into one-hot vectors may be used. Alternatively, as the training data, the information relating to the intensity distribution of the cell group in a known nutritional state, or the scattered light intensity information or the autofluorescence intensity information itself may be used as the training data.

### Second Embodiment

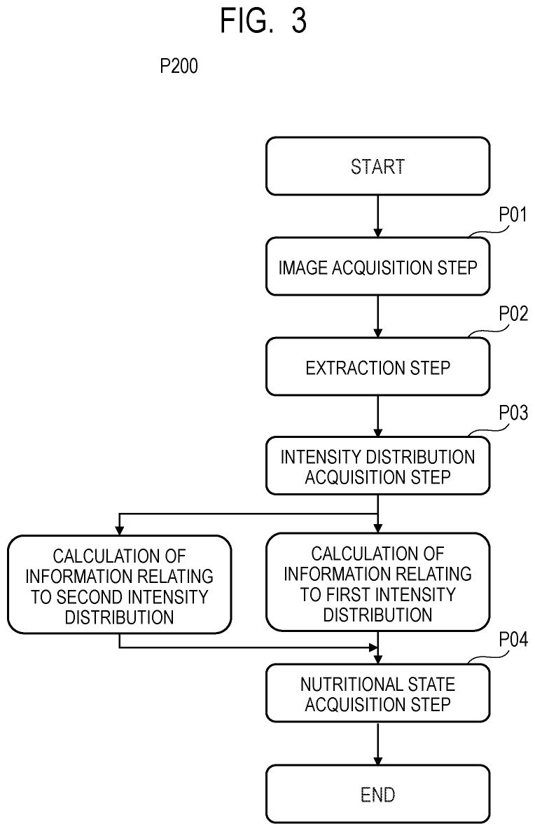

FIG. 3 is a flowchart showing an example of a configuration of an information acquisition method in a second embodiment.

### Second Cell Group

In the present embodiment, in step P03, information relating to a second intensity distribution calculated from a scattered light image or an autofluorescence image of a second cell group different from the cell group may be acquired as a second feature value, and based on this, the nutritional state of the cell group may be further acquired in step P04.

The second feature value may be information relating to the second intensity distribution calculated in step P03 from a second image obtained by capturing scattered light or autofluorescence generated by irradiating the second cell group with light, and from a second cell region that is a region of the cell group in the second image.

The second feature value may be acquired in advance. That is, the second feature value may be obtained by reading, from a storage apparatus, information relating to the intensity distribution that has been stored in the storage apparatus in the past. Alternatively, the second feature value may be calculated in step P03 by reading, from the storage apparatus, the second image obtained by capturing scattered light or autofluorescence generated by irradiating the second cell group with light and previously stored in the storage apparatus, and the second cell region that is a region of the second cell group in the second image. In this case, images can be captured using the same apparatus under similar imaging conditions.

With respect to the information relating to the intensity distribution and the information relating to the second intensity distribution, intensity information standardized using a standard substance may be used. For example, resin beads or part of a culture vessel itself may be used as the standard substance.

Alternatively, information relating to the second intensity distribution generated using an embodiment other than the present embodiment may be used. In this case, intensity information that has been standardized using a reference substance can be used.

### Standard State Sample

The second group of cells may use a standard state sample. The standard state sample may be any sample provided that an operator wishes to this sample as reference. For example, cells used in routine tasks such as cell culture, or cells from stock that have just been thawed can be used as the standard cells, and a sample including the standard cells can be used as the standard state sample.

### Program, Recording Medium

As a further embodiment, the present disclosure provides a program for causing a computer to execute the above-described information acquisition method, and a computer-readable recording medium storing the program.

### Analysis Apparatus

As a further embodiment, the present disclosure provides an analysis apparatus including the image acquisition apparatus and the image processing apparatus that executes the above information acquisition method.

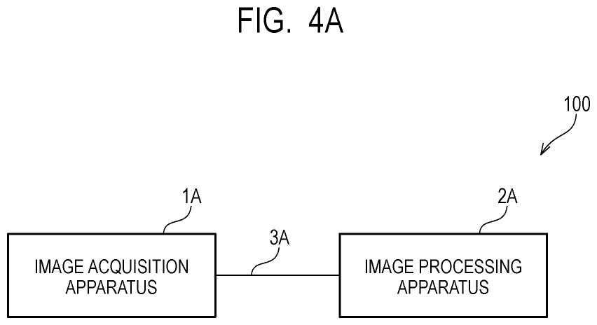

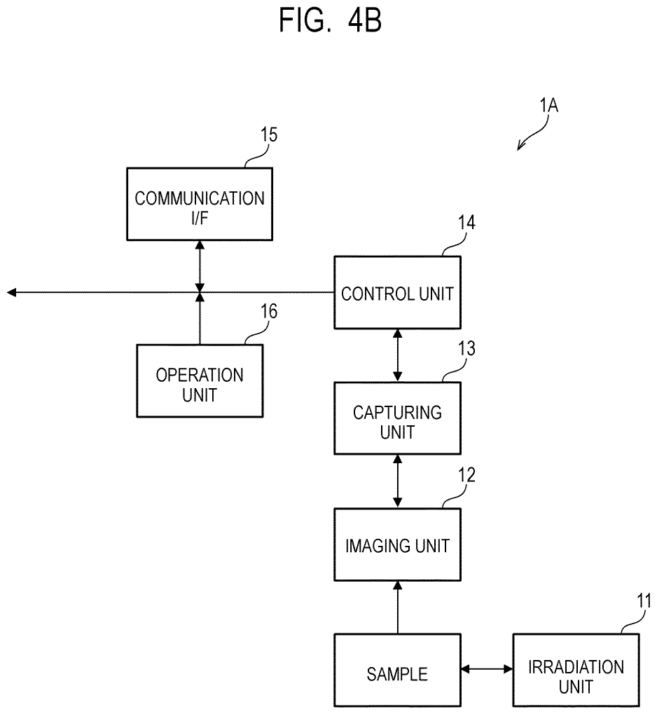

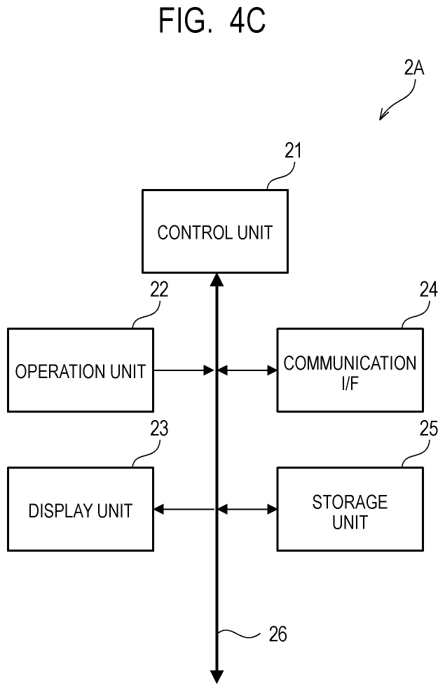

FIG. 4A shows a configuration of an analysis apparatus 100 in the present embodiment. As shown in FIG. 4A, in the analysis apparatus 100, an image acquisition apparatus 1A and an image processing apparatus 2A are connected via an interface such as a cable 3A to enable data transmission and reception. Note that a connection method between the image acquisition apparatus 1A and the image processing apparatus 2A is not particularly limited. For example, the image acquisition apparatus and the image processing apparatus may be connected via a local area network (LAN) or may be connected wirelessly.

The image acquisition apparatus 1A acquires an image of cells in a cell culture vessel or tissue sections on a glass slide placed on a mounting stage, and transmits the image to the image processing apparatus 2A.

An example of a configuration of the image acquisition apparatus 1A is shown in FIG. 4B. The image acquisition apparatus 1A includes an irradiation unit 11, an imaging unit 12, a capturing unit 13, control unit 14, a communication I/F 15, an operation unit 16, and the like. The irradiation unit 11 includes a light source filter and a light source, and irradiates cultured cells or tissue sections placed on the mounting stage with light. The imaging unit 12 includes an eyepiece lens, an objective lens, a filter, and the like, and captures transmitted light, reflected light, or fluorescence emitted from cells in a cell culture vessel or tissue sections on a slide by using the illumination light. The capturing unit 13 is, for example, a camera including a complementary MOS (CMOS) sensor and the like, which captures an image formed on an imaging surface by the imaging unit and generates digital image data (R, G, B image data) of the image. The control unit 14 includes a central processing unit (CPU), random-access memory (RAM), and the like. The control unit 14 executes various processing in cooperation with various programs installed internally. The communication I/F 15 transmits the image data of the generated image to the image processing apparatus 2A. The operation unit 16 includes a keyboard with character input keys, numeric input keys, and various function keys, as well as a pointing device such as a mouse. The operation unit 16 outputs key press signals from the keys pressed on the keyboard and operation signals from the mouse to the control unit 14 as input signals.

The image processing apparatus 2A uses the image transmitted from the image acquisition apparatus 1A to acquire the information relating to the nutritional state of the cell group.

FIG. 4C shows an example of a configuration of the image processing apparatus 2A. The image processing apparatus 2A includes a control unit 21, an operation unit 22, a display unit 23, a communication I/F 24, a storage unit 25, and the like. Each unit is connected via a bus 26.

The control unit 21 includes a CPU and the like. The control unit 21 executes various processing in cooperation with various programs stored in the storage unit 25, and comprehensively controls an operation of the image processing apparatus. For example, the control unit 21 executes image processing in cooperation with a program stored in the storage unit 25. The control unit analyzes the image transmitted from the image acquisition apparatus 1A.

The operation unit 22 includes a keyboard with character input keys, numeric input keys, and various function keys, as well as a pointing device such as a mouse. The operation unit 22 outputs key press signals from the keys pressed on the keyboard and operation signals from the mouse to the control unit 21 as input signals.

The display unit 23 includes a monitor such as a cathode-ray tube (CRT) or a liquid-crystal display (LCD), and displays various screens according to instructions of display signals input from the control unit 21. In the present embodiment, the display unit 23 functions as a means for displaying, for example, the calculated information relating to the nutritional state of the cell group (including a graph of the information), the calculated feature value, a graph based on the feature value, a classification result, or a phenotype corresponding to the classified group.

The communication I/F 24 is an interface for transmitting and receiving data to and from external devices, including the image acquisition apparatus 1A. The communication I/F 24 functions as an input means for the bright-field image, the fluorescence image, and the scattered light image. In the present embodiment, the communication I/F 24 functions as the input means.

The storage unit 25 includes, for example, a hard disk drive (HDD), a non-volatile semiconductor memory, and the like. Various programs, various data, and the like are stored in the storage unit 25 as described above. For example, the storage unit 25 stores various data, including a magnification table used in image analysis processing described below.

Alternatively, the image processing apparatus 2A may include a LAN adapter, a router, and the like, and may be connected to an external device via a communication network such as a LAN.

### EXAMPLES

Hereinafter, more detailed description will be provided by using examples. The present disclosure is not limited to the following examples.

### Example 1

### Subject

In Example 1, cells derived from the lung of a Chinese hamster (CHL-YN) was used. Cells were shake-cultured in a flask (Thermo Fisher Scientific: Nunc EasYFlask, 25 cm²) containing 5 mL of a culture medium (Sigma-Aldrich: Ex-Cell CD CHO Fusion) in an incubator maintained at a temperature of 37° C. and a carbon dioxide concentration of 5%. After cultivation, the cells reached confluence and aggregated cells were observed. The culture medium was collected and stored as a conditioned medium.

Separately, CHL-YN cells were cultured in the culture medium, and four samples were prepared under the same conditions. For these cells, the culture medium was replaced with (1) conditioned medium, (2) glucose-supplemented conditioned medium (with glucose added), (3) glutamine-supplemented conditioned medium (with glutamine added), and (4) unused medium as a reference. The following day, autofluorescence observation of the cells was performed.

At the time of observation, a small amount of the culture medium in the flask was collected, suspended in D-PBS(−) (Dulbecco's Phosphate-Buffered Saline (−), FUJIFILM Wako Pure Chemical Corporation), seeded onto a D35 mm glass-bottom dish (Matsunami Glass Ind., Ltd.: D11141H), allowed to settle, and then used for observation.

### Image Acquisition

A subject was irradiated with light by using an illumination system combining a high-brightness LED light source, a quartz bundle fiber, and a telecentric lens.

For capturing, a commercially available mirrorless digital single-lens camera equipped with a full-frame (36 mm×24 mm) 8K-pixel color CMOS sensor was used, together with a commercially available telecentric lens having a magnification of 2× and an appropriate observation filter for cutting the illumination light. An autofluorescence image having a field of view of 18 mm×12 mm and a resolution of 8191×5463 pixels was acquired. Cells within a field of view were treated as a cell group and used as a target for acquiring the information relating to the nutritional state. A spatial resolution per pixel was approximately 2.2 μm, which was sufficiently smaller than cells having a diameter of about 10 μm.

The combinations of irradiation wavelength/observation wavelength were set to 365 nm/400 nm or more, 395 nm/400 nm or more, 395 nm/530 nm or more, and 470 nm/530 nm or more.

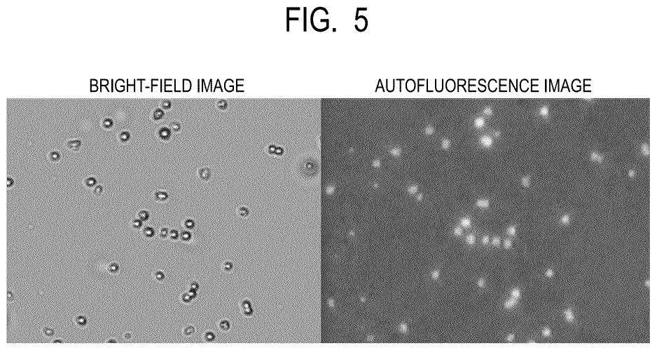

A bright-field image using transmitted illumination was captured as the image for region extraction. An example of a cell imaging result obtained using the above bright-field and autofluorescence images is shown in FIG. 5.

### Intensity Extraction

A cell contour of each cell was extracted from the bright-field image and a mask image was generated. The autofluorescence image was superimposed on the mask image, and an area of the cell region, as well as the average value, the maximum value, and the median value of the pixel intensity of the autofluorescence image were acquired.

### Analysis

The intensity observed under 365-nm irradiation/400-nm or more observation is referred to as autofluorescence intensity (B). NAD(P)H is observed at autofluorescence intensity (B). NAD(P)H is typically produced more actively as glycolysis becomes more active.

The intensity observed under 395-nm irradiation/530-nm or more observation is referred to as autofluorescence intensity (G). Flavins are observed at autofluorescence intensity (G). Flavins typically decrease as the TCA cycle becomes more active.

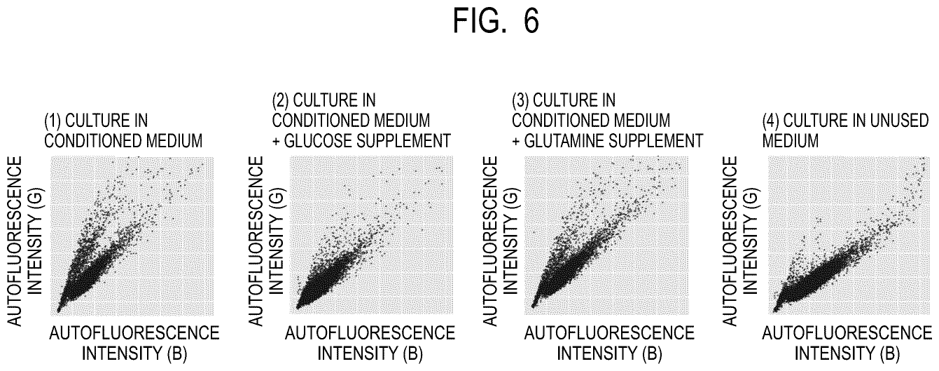

FIG. 6 shows the pixel intensity of each sample in scatter plots, the autofluorescence intensity (B) being on the horizontal axes and the autofluorescence intensity (G) being on the vertical axes.

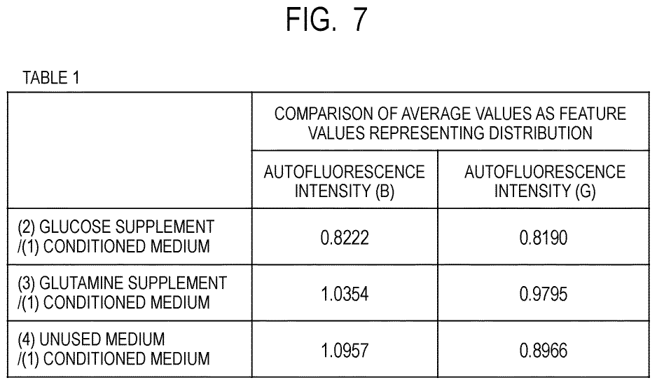

Table 1 of FIG. 7 shows, as the feature values in the present example, ratios between samples of the average value of the autofluorescence intensity (B) and ratios between samples of the average value of the autofluorescence intensity (G).

For (4) unused medium/(1) conditioned medium, the autofluorescence intensity (B) was greater than 1. That is, cells cultured using (1) conditioned medium exhibited lower autofluorescence intensity (B) than cells cultured using (4) unused medium. This indicates that glycolysis was reduced in the conditioned medium. This reduction is considered to be due to an overall deficiency of nutrients such as glucose, which is the substrate for glycolysis, and lipids and glutamine, which are the substrates for the TCA cycle.

For (4) unused medium/(1) conditioned medium, the autofluorescence intensity (G) was less than 1. That is, cells cultured using (1) conditioned medium exhibited higher autofluorescence intensity (G) than cells cultured using (4) unused medium. This indicates that the TCA cycle was reduced in the conditioned medium. It is considered that the reduction in glycolysis was accompanied by the reduction in the TCA cycle.

On the other hand, for (2) glucose supplement/(1) conditioned medium, both the autofluorescence intensity (B) and the autofluorescence intensity (G) were less than 1. That is, cells cultured with glucose supplementation exhibited lower autofluorescence intensity (B) and autofluorescence intensity (G) than cells cultured using the conditioned medium. This indicates that glycolysis was reduced and the TCA cycle was enhanced in cells cultured with glucose supplementation.

In cells cultured with glucose supplementation, it is inferred that the addition of a sufficient amount of glucose, which is the substrate for glycolysis, resulted in increased intracellular production of pyruvate, which is both a product of glycolysis and the substrate for the TCA cycle. Because the TCA cycle has higher energy production efficiency than glycolysis, when sufficient substrate is available and the TCA cycle is active, it is considered unnecessary for glycolysis, which has relatively lower energy efficiency, to operate actively.

On the other hand, for (3) glutamine supplement/(1) conditioned medium, both the autofluorescence intensity (B) and the autofluorescence intensity (G) were close to 1, indicating that glutamine supplementation had little effect on the autofluorescence intensity (B) and the autofluorescence intensity (G). Although glutamine is the substrate for the TCA cycle, these results suggest that a sufficient amount of glutamine remained during preparation of the conditioned medium, and therefore supplementation had no effect.

From the above, it can be said that the nutritional state of cells can be determined based on information relating to the autofluorescence intensity distribution.

### Example 2

### Subject

In Example 2, CHL-YN cells were used. Cells were shake-cultured in a flask (Thermo Fisher Scientific: Nunc EasYFlask, 25 cm²) containing 5 mL of a culture medium (Sigma-Aldrich: Ex-Cell CD CHO Fusion) in an incubator maintained at a temperature of 37° C. and a carbon dioxide concentration of 5%.

CHL-YN cells were cultured in the above medium, and three samples were prepared under the same conditions. Subsequently, the medium of each sample was replaced with (1) glutamine-free medium, (2) medium containing 1.2 mM glutamine, and (3) medium containing 6 mM glutamine, and culturing was started. At 24 hours and 48 hours after replacement of the medium, autofluorescence images and scattered light images of the cells were captured. A small amount of the culture medium in the flask was collected and centrifuged, after which the cells were suspended in HBSS (−) (Hank's Balanced Salt Solution (−), Fujifilm Wako). The suspended cells were then seeded onto a b35 mm glass-bottom dish (Matsunami Glass Industry Co., Ltd.: D11141H), allowed to settle, and used for capturing.

### Image Acquisition

A subject was irradiated with light by using an illumination system combining a high-brightness LED light source, a quartz bundle fiber, and a telecentric lens.

For capturing, a commercially available mirrorless digital single-lens camera equipped with a full-frame (36 mm×24 mm) 8K-pixel color CMOS sensor was used, together with a commercially available telecentric lens having a magnification of 2× and an appropriate observation filter for cutting the illumination light. An image having a field of view of 18 mm×12 mm and a resolution of 8191×5463 pixels was acquired. The cells were treated as a cell group and used as a target for acquiring the information relating to the nutritional state. A spatial resolution per pixel was approximately 2.2 μm, which was sufficiently smaller than cells having a diameter of about 10 μm.

The combinations of autofluorescence irradiation wavelength/observation wavelength were set to 365 nm/400 nm or more, 395 nm/400 nm or more, 395 nm/530 nm or more, and 470 nm/530 nm or more. The irradiation wavelength of the scattered light was 525 nm. A bright-field image using transmitted illumination was captured as the image for region extraction.

### Intensity Extraction

A cell contour of each cell was extracted from the bright-field image and a mask image was generated. The mask image was superimposed on the autofluorescence image or the scattered light image, and the average value, the maximum value, the median value, the area, and the like of the pixel intensity in each cell region in the autofluorescence image or the scattered light image were acquired.

### Analysis

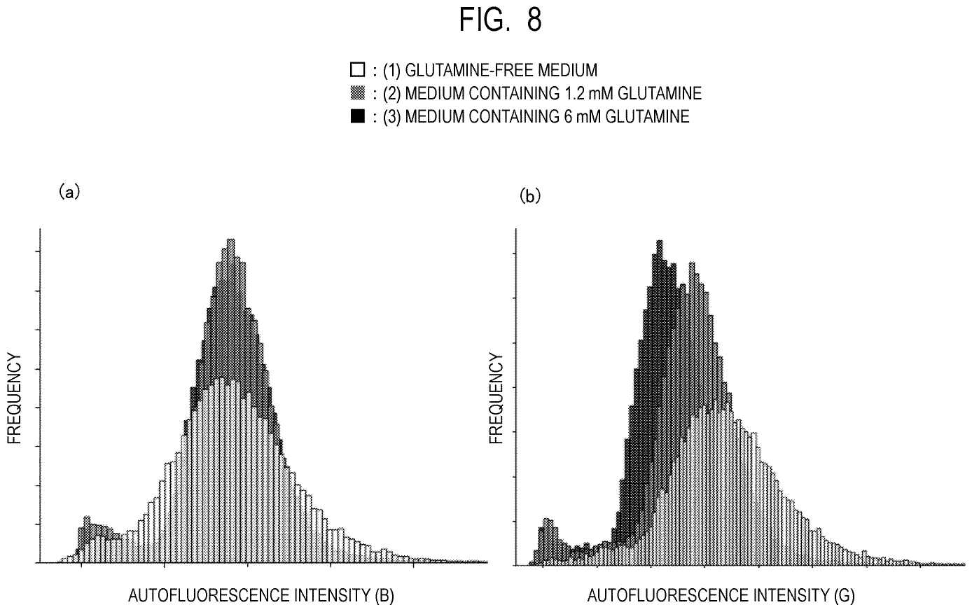

FIG. 8 shows histograms of the autofluorescence intensity (B) and the autofluorescence intensity (G) after 24 hours. The horizontal axis represents the average pixel intensity within each cell region in the autofluorescence image, and the vertical axis represents frequency.

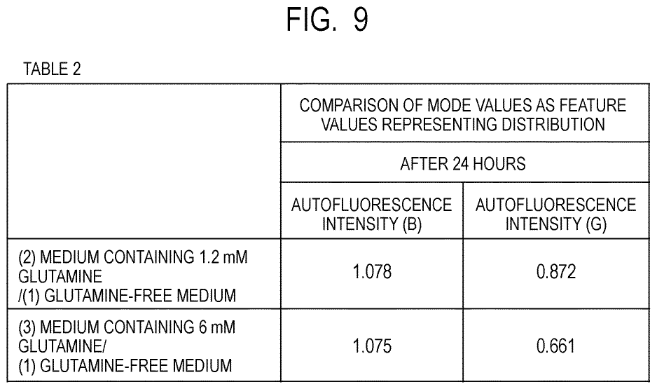

Table 2 of FIG. 9 shows, as the feature values in the present example, ratios between samples after 24 hours of the mode values of the autofluorescence intensity (B) and the autofluorescence intensity (G).

As shown in Table 2, for (2) medium containing 1.2 mM glutamine/(1) glutamine-free medium and for (3) medium containing 6 mM glutamine/(1) glutamine-free medium, the autofluorescence intensity (G) was less than 1 in both cases. That is, the autofluorescence intensity (G) of the medium containing glutamine was lower than the autofluorescence intensity (G) of the glutamine-free medium. This indicates that the TCA cycle was restored by the addition of glutamine.

For (2) medium containing 1.2 mM glutamine/(1) glutamine-free medium and for (3) medium containing 6 mM glutamine/(1) glutamine-free medium, the autofluorescence intensity (B) was close to 1. This indicates that glycolysis was not significantly affected by the addition of glutamine. Since the amount of added glucose was not changed, it was expected that glycolysis would exhibit little change, and the obtained results were consistent with this expectation.

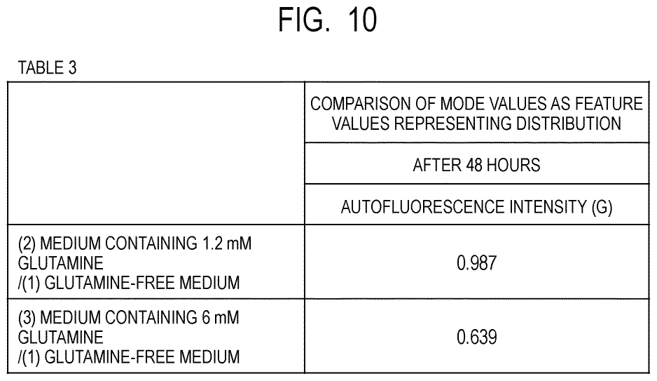

Table 3 of FIG. 10 shows, as the feature values in the present example, ratios between samples after 48 hours of the mode value of the autofluorescence intensity (G). As shown in Table 3, for the autofluorescence intensity (G), a ratio of (2) medium containing 1.2 mM glutamine/(1) glutamine-free medium came closer to 1 when compared to the result after 24 hours, where for (3) medium containing 6 mM glutamine/(1) glutamine-free medium, there was little change from the result after 24 hours. This indicates that during cultivation from 24 to 48 hours, glutamine in the medium was gradually consumed, and in particular, under the cultivation conditions of (2), glutamine became depleted, causing the culture state to approach that of (1), the glutamine-free medium. On the other hand, under the cultivation conditions of (3), a sufficient amount of glutamine remained, and it is inferred that the ratio of autofluorescence intensity did not change during the 24 to 48 hours cultivation period because glutamine was still present at 48 hours. From the above, it can be said that the nutritional state of cells can be determined based on information relating to the autofluorescence intensity distribution.

### Example 3

A scattered light image (525-nm irradiation) was captured for a sample similar as in Example 2.

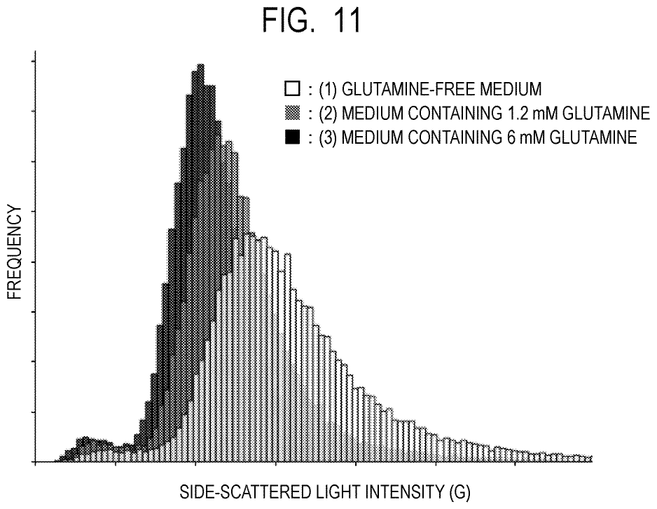

FIG. 11 shows a histogram visualizing the intensity (side-scattered light intensity (G)) obtained from the scattered light image (525-nm irradiation) of each sample cultured in (1) glutamine-free medium, (2) medium containing 1.2 mM glutamine, and (3) medium containing 6 mM glutamine. The horizontal axis represents the average pixel intensity within each cell region in the scattered light image (scattered light intensity (G)), and the vertical axis represents frequency.

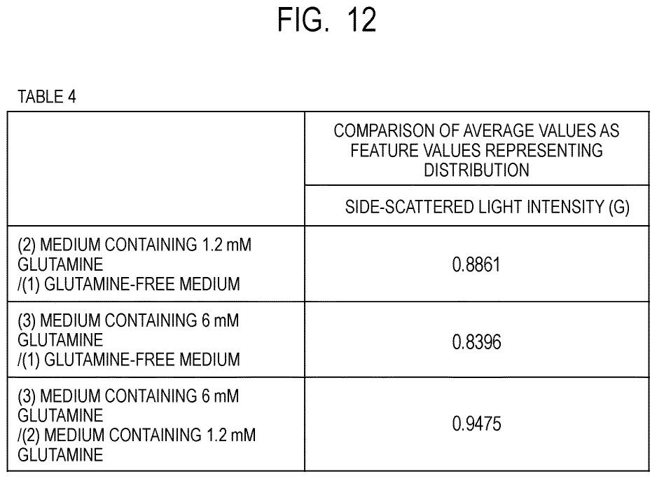

Table 4 of FIG. 12 shows, as the feature values in the present example, ratios between samples of the average value of the autofluorescence intensity (G).

As shown in Table 4, for the scattered light intensity, the ratios of (2) medium containing 1.2 mM glutamine/(1) glutamine-free medium, (3) medium containing 6 mM glutamine/(1) glutamine-free medium, and (3) medium containing 6 mM glutamine/(2) medium containing 1.2 mM glutamine were all less than 1. This indicates that scattered light intensity increases in the order of (1) glutamine-free medium>(2) medium containing 1.2 mM glutamine>(3) medium containing 6 mM glutamine.

It is inferred that, in the order of decreasing glutamine concentration in the medium, the glutamine serving as a substrate for the TCA cycle becomes increasingly deficient, resulting in a greater decrease in mitochondrial energy metabolism. Mitochondria with reduced metabolic activity are more likely to undergo fission, leading to an increase in fragmented mitochondria. Cultivation under nutrient-deficient conditions may have induced autophagy, potentially resulting in the formation of autophagosomes, which are microstructures. For these reasons, the complexity of intracellular structures is thought to have increased, thereby elevating scattered light intensity.

From the above, it can be said that the nutritional state of cells can be determined based on information relating to the scattered light intensity distribution of the cells.

According to one embodiment of the present disclosure, information relating to a nutritional state of a cell sample can be obtained by using a scattered light image and an autofluorescence image of a cell group. In a method using a flow cytometer, cells must be observed in flow. On the other hand, the method of the present disclosure uses an image and does not rely on flow observation. Accordingly, information relating to the nutritional state can be obtained in real-time for cells in culture, in sections, in tissue, and in biological samples. The information relating to the nutritional state can be obtained for adherent cells, which are difficult to observe in flow.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-058628, filed Mar. 31, 2025, which is hereby incorporated by reference herein in its entirety.

What is claimed is:

1. An information acquisition method of acquiring information relating to a nutritional state of a cell group from an image including the cell group, the information acquisition method comprising:
an image acquisition step of acquiring an image including at least one of a scattered light image of the cell group and an autofluorescence image of the cell group;
an extraction step of extracting individual cell regions of the cell group in the image;
an intensity distribution acquisition step of calculating intensity information of the individual cell regions, and further acquiring information relating to an intensity distribution of the cell group from the intensity information of the individual cell regions as a feature value of the cell group; and
a nutritional state acquisition step of acquiring information relating to the nutritional state of the cell group, based on the information relating to the intensity distribution of the cell group, wherein
the information relating to the nutritional state includes information relating to an amount of at least one selected from the group consisting of sugars, lactic acid, pyruvic acid, glutamine, glutamic acid, and lipids provided to the cell group.

2. The information acquisition method according to claim 1, wherein
the feature value is a statistical value of the intensity distribution of the cell group.

3. The information acquisition method according to claim 2, wherein
the statistical value of the intensity distribution of the cell group includes at least one selected from the group consisting of an average value, a median value, a mode value, a variance, a deviation, an interquartile range, and a half width of intensity values of the individual cell regions.

4. The information acquisition method according to claim 1, wherein
the feature value is a parameter obtained by fitting the intensity distribution of the cell group to a theoretical distribution.

5. The information acquisition method according to claim 4, wherein
the theoretical distribution is one selected from the group consisting of a Gaussian distribution, an ex-Gaussian distribution, a shifted lognormal distribution, a shifted Wald distribution, a shifted Weibull distribution, and a Gumbel distribution.

6. The information acquisition method according to claim 1, wherein
the feature value is a parameter obtained by fitting the intensity distribution of the cell group by using unsupervised machine learning.

7. The information acquisition method according to claim 6, wherein
the unsupervised machine learning uses a GMM.

8. The information acquisition method according to claim 1, further comprising:
a second intensity distribution acquisition step of acquiring, as a second feature value, information relating to an intensity distribution of individual cell regions of a second cell group different from the cell group, calculated based on a second image including at least one of a scattered light image of the second cell group and an autofluorescence image of the second cell group, wherein
in the nutritional state acquisition step, the information relating to the nutritional state of the cell group is acquired based on the feature value and the second feature value.

9. The information acquisition method according to claim 8, wherein
the second cell group includes standard cells.

10. The information acquisition method according to claim 8, further comprising:
a second image acquisition step of acquiring the second image including at least one of the scattered light image of the second cell group and the autofluorescence image of the second cell group; and
a second extraction step of extracting the individual cell regions of the second cell group in the second image.

11. The information acquisition method according to claim 8, wherein
the second feature value is acquired in advance.

12. The information acquisition method according to claim 8, wherein
the second image is acquired in advance.

13. The information acquisition method according to claim 8, wherein
the information relating to the intensity distribution of the individual cell regions of the second cell group is standardized by using a standard substance.

14. The information acquisition method according to claim 1, wherein
in the nutritional state acquisition step, the information relating to the nutritional state of the cell group is acquired by using supervised machine learning.

15. The information acquisition method according to claim 14, wherein
a trained model is used that has been trained by using the information relating to the intensity distribution as input and the information relating to the nutritional state as output.

16. The information acquisition method according to claim 1, wherein
the scattered light image is captured at an angle of 5 degrees or more formed by a direction of illumination light and a capturing direction.

17. The information acquisition method according to claim 1, wherein
the scattered light image is captured at an angle of 30 degrees or more formed by a direction of illumination light and a capturing direction.

18. A computer-readable non-transitory recording medium storing a program for causing a computer to execute the information acquisition method according to claim 1.

19. An analysis apparatus comprising:
an image acquisition apparatus, and an image processing apparatus configured to execute the information acquisition method according to claim 1.
